(19) United States
(12) Patent Application Publication
(10) Pub. No.: US 2026/0291723 A1
(43) Pub. Date: Sep. 24, 2026

(54) MULTI-PARTY COMPUTATION METHOD AND SYSTEM FOR DISTRIBUTED PROCESSORS WITH ASYMMETRIC NETWORK RESOURCES

(71) Applicant: NTT Research, Inc., Sunnyvale, CA (US)

(72) Inventors: Vipul Goyal, Pittsburgh, PA (US); Chen-Da Liu-Zhang, Zurich (CH); Rafail Ostrovsky, Santa Monica, CA (US)

(73) Assignee: NTT Research, Inc., Sunnyvale, CA (US)

(21) Appl. No.: 19/470,055

(22) PCT Filed: Mar. 31, 2024
(86) PCT No.: PCT/US24/22432

§ 371 Date: Sep. 28, 2025

Related U.S. Application Data
(60) Provisional application No. 63/493,720, filed on Mar. 31, 2023.

(51) Int. Cl. H04L 9/08

(52) U.S. Cl. CPC H04L 9/0869; H04L 9/0894; H04L 2209/46; H04L 2209/50

(57) ABSTRACT

A method for asymmetric multi-party computation involves establishing data communications channels over a network among distributed computerized processors, which are divided into fast and slow parties based on network performance metrics. During a preprocessing phase, the fast parties perform an oblivious transfer-extension protocol to generate correlated randomness values. Unique inputs are stored at both the fast and slow parties. The fast parties then execute an unconditional oblivious transfer-based protocol to generate an output, which is stored and transmitted to all other parties. The total number of communicated bits over channels with larger delay is independent of a circuit size.

### CROSS-REFERENCE TO RELATED APPLICATION

This application claims the benefit of U.S. Provisional Application Ser. No. 63/493,720 filed Mar. 31, 2023, the content of which is incorporated by reference herein in its entirety.

### FIELD OF THE INVENTION

The present disclosure generally relates to the field of secure multi-party computation in distributed computer systems, and more specifically, to methods and systems for efficient computation among asymmetric parties with varying network resources.

### BACKGROUND OF THE INVENTION

In the field of distributed computing, secure multi-party computation (MPC) is a subfield of cryptography that enables a group of parties, each possessing private data, to compute a function over their data without revealing their private inputs to each other. This concept is particularly useful in scenarios where multiple entities wish to collaborate on a computation without compromising the confidentiality of their individual data. Secure MPC allows a set of distrustful parties to compute a function over their private inputs, in such a way that nothing about the inputs is revealed beyond the output of the computation.

One of the main factors that can affect the efficiency and performance of an MPC protocol is the speed of the network connections between the participating parties. The speed of a network connection, often referred to as the “bandwidth,” is typically measured in bits per second (bps) and refers to the maximum amount of data that can be transmitted over the connection in a given time period. A higher bandwidth allows more data to be transferred simultaneously, resulting in a faster connection.

Another factor that can impact the performance of an MPC protocol is the delay, or “latency,” of the network connections. Latency refers to the amount of time it takes for a unit of data, typically a packet, to travel from the source device to the destination device across the network. A connection with lower latency is considered “faster,” as data can be exchanged more quickly between the device and the network.

In addition to bandwidth and latency, the type of network technology used can also affect the speed of a network connection. Different network technologies, such as Ethernet or Wi-Fi, have varying speed capabilities. For example, a device connected to a network using a modern Wi-Fi standard will generally have a faster connection than a device using an older standard.

Furthermore, the quality and capacity of the network infrastructure, including routers, switches, and cabling, can impact the speed of a network connection. A well-designed and maintained network with high-quality components can provide faster connections compared to a poorly designed or outdated network.

Finally, the hardware of the computing device itself, such as its network interface card (NIC), processor, and memory, can also affect the speed of its network connection. A device with a high-performance NIC and sufficient processing power can handle network traffic more efficiently, resulting in a faster connection.

Various tools and methods can be used to measure the bandwidth, latency, and overall performance of a network connection. These include online speed testing tools, command-line tools like ping, and network monitoring software applications. By considering these factors and using appropriate testing methods, it is possible to determine the relative speed of network connections between different computing devices.

Generally speaking, current MPC protocols consider the simplest setting where all parties have network resources with the same guarantees. In particular, the most common synchronous network model considers the setting where all channel delays are upper bounded by a single worst-case delay Δ and all channels have the same cost of communication.

Even though this model is theoretically interesting, it suffers from important practical limitations. In particular, Δ has to be set large enough to accommodate any possible delay: Even in cases where almost all parties have fast channels with delay δ«Δ, the protocols do not take advantage of this, and the running time of the protocol is affected by the slowest party. This is particularly critical for information-theoretic protocols, where all current solutions have a round complexity that depends on the depth of the circuit to evaluate. Similarly, the protocols designed in this model also fail to take advantage of the cost of communication from channels that are cheap, and the total communication cost is affected by the most expensive channel.

Considering parties with asymmetric resources allows us to not only model more realistic scenarios, where parties have access to different levels of resources, but also to design more refined protocols that exploit such asymmetries, thereby improving the performance and communication cost of protocols, while at the same time achieving more refined levels of security and assumptions.

Thus, there is a need to investigate what are the achievable trade-offs between the number of tolerated corruptions and slow parties compared to the number of slow rounds in the model with asymmetric delays. There is a further need to similarly investigate the trade-offs with respect to the number of bits transmitted over expensive channels in the model with asymmetric communication cost.

In summary, traditional MPC protocols assume a symmetric setting where all parties have similar computational and network resources. These protocols do not take into account the asymmetries in network resources and communication costs that are often present in real-world scenarios. This can lead to inefficiencies in the running time and communication cost of the protocols, particularly in scenarios where there is a large disparity in the resources of the participating parties.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Given the state of the art, we initiate the study of asymmetric MPC. In asymmetric MPC, the parties are divided into two categories. We consider fast parties, which are parties that have access to high-end network resources (e.g. channels with small delay, cheap channels, etc), and slow parties, which are parties that have access only to low-end network resources. One can think about the fast parties as parties that are in some sense privileged and have access to fast and cheap internet connection, e.g. with fiber, while slow parties are not so privileged, and only have access to slow and expensive connectivity, e.g. one may think of mobile devices or Internet of Things (IoT) devices such as sensors collecting data.

We investigate two different models. In the first, we consider asymmetric communication delays: Fast parties are connected via channels with small delay & among themselves, while channels connected to (at least) one slow party have a large delay Δ»δ. In the second model, we consider asymmetric communication costs: Fast parties benefit from channels with cheap communication, while channels connected to a slow party have an expensive communication.

A range of results can be achieved, based on the trade-offs between the achievable number of tolerated corruptions t and slow parties s, versus the round complexity and communication cost in each of the models. Some of the results are described herein.

In the model with asymmetric communication delays, focusing on the information-theoretic (i-t) setting:
An i-t asymmetric MPC protocol with security with abort as long as t+s<n and t<n/2, in a constant number of slow rounds.
We show that achieving an i-t asymmetric MPC protocol for t+s=n and with number of slow rounds independent of the circuit size implies an i-t synchronous MPC protocol with round complexity independent of the circuit size, which is a major problem in the field of round-complexity of MPC.
We identify a new primitive, asymmetric broadcast, that allows to consistently distribute a value among the fast parties, and at a later time the same value to slow parties. We completely characterize the feasibility of asymmetric broadcast by showing that it is possible if and only if 2t+s<n.
An i-t asymmetric MPC protocol with guaranteed output delivery as long as t+s<n and t<n/2, in a number of slow rounds independent of the circuit size.

In the model with asymmetric communication cost, we achieve an asymmetric MPC protocol for security with abort as long as t+s<n and t<n/2, based on one-way functions (OWF). The protocol communicates a number of bits over expensive channels that is independent of the circuit size. We conjecture that assuming OWF is needed and further provide a partial result in this direction.

An embodiment of the present disclosure encompasses a method for asymmetric multi-party computation. This method entails the establishment of data communications connections across a computerized network among a collection of distributed computerized processors. Within this collection, processors are categorized into two distinct subsets based on their relative processing speeds, with one subset comprising fast parties and the other comprising slower parties. The method includes the identification of these subsets, where the communication channels between fast parties are characterized by relatively small delays, and those involving at least one slow party are marked by larger delays.

During a pre-processing phase, the fast parties engage in an oblivious transfer (OT)-extension protocol to set up an OT channel between each pair of fast parties. This setup is instrumental in generating correlated randomness values, which remain undisclosed to other parties. Inputs are electronically stored at both the slow and fast parties, ensuring that each party's input is distinct and confidential. Subsequently, each of the fast parties executes an unconditional OT-based protocol, which is designed for scenarios involving a dishonest majority, to carry out instructions that result in the generation of an output. This output is then electronically stored at each of the fast parties.

Furthermore, the method includes the transmission of the output from each of the fast parties to all other parties, both fast and slow, over the established data communications channels. In some embodiments, the method stipulates an honest majority of parties, where the number of honest parties, denoted as t, is less than half of the total number of parties, n/2. Additionally, the method ensures that the total number of bits communicated over channels with larger delays remains independent of the size of the circuit involved in the computation.

In some instances, the slow parties are exempt from performing the executable instructions. Instead, the generation of correlations is conducted using an honest-majority multi-party computation (MPC) protocol. Alternatively, the correlated randomness may be generated by a trusted dealer who distributes a specific number of OT correlations, denoted as k, among the fast parties directly, with k serving as a security parameter. In particular embodiments, the slow parties are tasked with the sole responsibility of generating the MPC correlations.

The present disclosure also describes a system for asymmetric multi-party computation. This system comprises a network device configured to establish data communications channels over a computerized network among a set of distributed computerized processors. These processors are divided into relatively fast and slow parties. The system also includes a set of processors configured to identify the fast and slow parties based on predetermined or detected network performance metrics. During a pre-processing phase, the fast parties perform an OT-extension protocol to establish an OT channel between each pair of fast parties, thereby generating correlated randomness values. The fast parties are unaware of the other values during this process.

The system is designed to electronically store a set of inputs at both the slow and fast parties, with each party's input being uniquely known to them. Each of the fast parties is equipped to execute an unconditional OT-based protocol over the communication channels for a dishonest majority, executing instructions to generate an output. The output of the execution of the instructions is then electronically stored at each of the fast parties. Moreover, the network device is further configured to transmit the output from each of the fast parties to all other parties within the network.

In some embodiments, the system ensures an honest majority of parties, where t is less than n/2. The system is also designed such that the total number of communicated bits over channels with relatively larger delays is independent of the circuit size. In particular configurations, the slow parties do not perform the executable instructions. Instead, the correlations are generated using an honest-majority multi-party computation (MPC) protocol, or the correlated randomness is generated by a trusted dealer distributing k OT correlations among the fast parties directly, where k is a security parameter. In some cases, the slow parties are responsible for generating the MPC correlations.

Additionally, the disclosure includes a non-transitory processor-readable medium that stores code representing instructions to be executed by a processor at a compute device for asymmetric multi-party computation. The code comprises commands for establishing data communications channels over a computerized network among a set of distributed computerized processors. It also includes instructions for identifying the set of fast and slow parties based on predetermined or detected network performance metrics. During a pre-processing phase, the fast parties perform an OT-extension protocol to establish an OT channel between each pair of fast parties, generating correlated randomness values without knowledge of the other values.

The medium is configured to electronically store a set of inputs at the set of slow and fast parties, ensuring that each party's input is uniquely known to them. It also includes instructions for each of the fast parties to execute an unconditional OT-based protocol over the communication channels for a dishonest majority, executing instructions to generate an output. The output of the execution of the instructions is then electronically stored at each of the fast parties. Furthermore, the medium includes commands for transmitting the output from each of the fast parties to all other parties within the network.

In some embodiments, the medium ensures an honest majority of parties, where t is less than n/2. It is also configured such that the total number of communicated bits over channels with relatively larger delays is independent of the circuit size. In particular configurations, the slow parties do not perform the executable instructions and are responsible for generating the MPC correlations. The correlations may be generated using an honest-majority multi-party computation (MPC) protocol, or the correlated randomness may be generated by a trusted dealer distributing k OT correlations among the fast parties directly, where k is a security parameter.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 illustrates a schematic representation of an asymmetric multi-party computation system involving multiple processor nodes with varying channel speeds, according to aspects of the present disclosure.

FIG. 2 depicts a schematic representation of a networked system with multiple processor nodes, showing a triangular communication topology that accommodates the relative speeds of the participating nodes, according to aspects of the present disclosure.

FIG. 3 presents a block diagram of a computing device's core components, emphasizing the relationship between the processing unit, interface circuitry, and memory unit, and how these components may vary in performance, affecting the relative speed of the device in a multi-party computation system, according to aspects of the present disclosure.

FIG. 4 provides a block diagram of a computer system's core components, highlighting the role of each component in the system's operation and how differences in these components can contribute to the relative speed of the system in a networked environment, according to aspects of the present disclosure.

FIG. 5 presents a block diagram illustrating the flow of instructions within a computing system, demonstrating the specialized processing pathways for different types of instructions and how the processing speed may vary for different units within the system, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

We initiate a systematic study of asymmetric MPC with respect to two different models for network resources. In the first model, we consider a network with asymmetric communication delay. Fast parties are connected via channels with small delay δ among themselves, while all other channels, which are connected to a slow party, have a large delay Δ. In the second model, we consider a network with asymmetric communication cost. This means that fast parties benefit from channels with cheap communication, while other channels incur a high cost of communication.

Our focus is on minimizing the complexity from the slow parties (minimizing the number of slow rounds, respectively the usage of expensive channels) while at the same time tolerating as many corruptions and slow parties as possible. This allows us to give a first overall study of asymmetric MPC protocols in a clean manner.

No previous work has addressed the setting of asymmetric MPC, for any of the resource models. For example, synchronous protocols assume that all channels have the same worst-case delay and also that the cost of communication is the same for all channels. Similarly, asynchronous protocols assume that all channels have eventual delivery, and that all channels have the same cost of communication.

Note, however, that existing protocols using standard cryptographic assumptions do achieve a constant number of slow rounds, and FHE-based protocols achieve low communication over expensive channels, so our focus is on information-theoretic protocols when minimizing the number of slow rounds, and non-FHE protocols when minimizing the communication over expensive channels.

1 MPC with Asymmetric Delays

### The Model.

As mentioned above, in this model we divide the parties into two categories: fast and slow parties. Parties have access to a complete network of point-to-point (P2P) channels. The channels between fast parties have a small delay δ and are denoted fast channels, and all the other channels, i.e. the channels that contain at least one slow party, have a large delay Δ and are denoted slow channels.

We are interested in counting the number of slow P2P-rounds, which are the number of P2P communication steps via all channels, and the number of fast rounds, which are the number of P2P communication steps via the fast channels. Optimally, we would like to find protocols that have a constant number of slow P2P-rounds, or at least a number of slow P2P-rounds that is independent of the circuit to evaluate. Throughout the disclosure, we will omit the P2P term, and simply denote such rounds as fast and slow rounds.

### Existing Solutions.

Current constant-round solutions based on cryptographic assumptions, are already asymmetric MPC protocols with a constant number of slow rounds. This is because any constant-round synchronous MPC protocol trivially implies an asymmetric MPC protocol in our setting with a constant number of slow rounds.

### Information-Theoretic Protocols.

Information-theoretic protocols are much more interesting, since all current synchronous solutions require a number of rounds proportional to the depth of the circuit to evaluate. This is in stark contrast with protocols in our model, where we will be able to achieve a number of slow rounds that is independent of the circuit (sometimes even constant). We propose several information-theoretic protocols for the setting of malicious security, with abort and with guaranteed output delivery.

In the following, we let C be the circuit to evaluate, and let n, s, t be the number of parties, bound on the number of slow parties, and bound on the number of corruptions.

Security with Abort.

We first present a protocol that achieves security with abort and is secure as long as t+s<n and t<n/2. The round complexity is O(1) slow rounds and O(depth(C) fast rounds.

Theorem 1. Let n, s, t be natural numbers such that t+s<n and t<n/2. There is an information-theoretic asymmetric MPC protocol among n parties that securely evaluates circuit C with security with abort, in the presence of up to t malicious corruptions and s slow parties. The round complexity is O(1) slow rounds and O(depth(C)) fast rounds.

We then show that improving the resiliency of our asymmetric MPC protocol requires a breakthrough. Assume that t+s=n. Then, the following result implies that information-theoretic asymmetric MPC in a constant number of slow rounds implies constant-round information-theoretic MPC in the synchronous model resilient up to 1 corruption, which is known to be a major barrier in information-theoretic MPC.

Theorem 2. Let n, s, t>0 be natural numbers such that t+s=n. Then n-party information-theoretic asymmetric MPC with security with abort (resp. guaranteed output delivery), resilient up to t corruptions and s slow parties in R slow rounds, implies (s+1)-party information-theoretic synchronous MPC with security with abort (resp. guaranteed output delivery), resilient up to 1 corruption in R rounds.

### Guaranteed Output Delivery.

In the setting of malicious security with guaranteed output delivery, we present two results.

A Protocol for 2t+s<n and t<n/3. We start by presenting a solution for an information-theoretic protocol with guaranteed output delivery in the regime where 2t+s<n and t<n/3 (with no setup nor broadcast).

Theorem 3. Let k be a security parameter. Let n, s, t be natural numbers such that 2t+s<n and t<n/3. There is an asymmetric MPC protocol among n parties that securely evaluates circuit C with guaranteed output delivery in the presence of up to t malicious corruptions and s slow parties. The round complexity is O(κ) slow rounds and O(depth(C)·κ) fast rounds.

In the above theorem statement, if synchronous broadcast channels are assumed as setup (or alternatively, a setup for i−t signatures, the condition t<n/3 is not necessary.

The above protocol inherently requires the condition 2t+s<n. However, optimally one would wish to require an honest majority overall, rather than among the fast parties. This means, that we want to find protocols that deal with a dishonest majority among the fast parties.

Broadcast with Asymmetric Delays. To overcome this bound, we identify a natural primitive in our setting with asymmetric delays, called asymmetric broadcast. This primitive ensures that all the fast parties obtain the output within d_{bc} fast rounds, while slow parties obtain the same output much later, within D_{bc} slow rounds. We call the quantity d_{bc} the fast asymmetric broadcast delay, and D_{bc} the slow asymmetric broadcast delay.

Our first step is to investigate the possible trade-offs for asymmetric broadcast. Our results completely characterize the feasibility of asymmetric broadcast from point-to-point channels, by showing matching positive and negative results.

First, in Section 5.2, we show a simple construction of n-party asymmetric broadcast with a fast sender, where d_{bc} and D_{bc} are O(κ), and security holds up to t corruptions and s slow parties, as long as 2t+s<n, assuming a PKI setup for signatures. The theorem holds also unconditionally, if the setup consists of information-theoretic signatures.

Theorem 4. Let n, s, t be natural numbers such that 2t+s<n. Assuming a PKI setup for signatures, there is an n-party asymmetric broadcast protocol with d_{bc}=D_{bc}=O(κ), tolerating t malicious corruptions and s slow parties.

Perhaps surprisingly, this is the best trade-off one can achieve, and tolerating 2t+s=n for any non-trivial parameters t>0 and s>0 is impossible, even with setup, and for any number of fast and slow rounds.

Theorem 5. Let n, s, t>0 be natural positive numbers such that 2t+s=n. Then, asymmetric broadcast is impossible against t malicious corruptions and s slow parties, even with setup.

A Protocol for t+s<n and t<n/2. We now present an asymmetric MPC protocol where parties have access to asymmetric broadcast channels with fast and slow delays d_{bc} and D_{bc}, and achieve a protocol that is secure as long as t+s<n and t<n/2. The round complexity is O(n·D_{bc}) slow rounds and O(depth(C)·n·d_{bc}) fast rounds. In the optimistic case where no party is corrupted, we save a factor n in the round complexity. That is, in this case the protocol incurs O(D_{bc}) slow rounds and O(depth(C)·d_{bc}) fast rounds.

Theorem 6. Let n, s, t be natural numbers such that t+s<n and t<n/2. Assuming asymmetric broadcast with slow and fast delays D_{bc} and d_{bc}, there is an asymmetric MPC protocol among n parties that securely evaluates circuit C with guaranteed output delivery, in the presence of up t corruptions and s slow parties. The round complexity is O(n·D_{bc}) slow rounds and O(depth(C)·n·d_{bc}) fast rounds. In the optimistic case where no party is corrupted, the round complexity is O(D_{bc}) slow rounds and O(depth(C)·d_{bc}) fast rounds.

The number of rounds in the protocol above has a linear dependency in the number of parties in the worst case. This linear dependency can be removed at the cost of requiring any constant fraction of honest parties among the fast parties.

Corollary 1. Let ∈>0 and n, s, t be natural numbers such that t<min{(1−E)(n−s), n/2}. Assuming asymmetric broadcast with slow and fast delays D_{bc} and d_{bc}, there is an asymmetric MPC protocol among n parties that securely evaluates circuit C with guaranteed output delivery, in the presence of up to t corruptions and s slow parties. The round complexity is O(D_{bc}) slow rounds and O(depth(C)·d_{bc}) fast rounds.
2 MPC with Asymmetric Communication Cost

The Model. Similar to the previous model, we divide the parties into two categories: fast and slow parties. Parties have access to a complete network of standard synchronous point-to-point channels with the same delay upper bound. However, now the channels are differentiated with respect to the cost of communication. The channels between fast parties have a small cost and are denoted by cheap channels, and all other channels, i.e. the channels that contain at least one slow party as sender or receiver, have a high cost and are denoted by expensive channels.

We are interested in minimizing the number of bits transmitted over the expensive channels. Note that slow parties need to distribute their inputs, so the number of transmitted bits over expensive channels will definitely depend (at least) on the total number of slow parties and their input size. Our main focus is therefore that the number of bits over expensive channels does not depend on the circuit to evaluate.

### Existing Solutions.

Note that current solutions that make use of (multi-key) fully-homomorphic encryption (FHE) already transmit a number of bits over expensive channels that is independent of the circuit to evaluate, given that the computation is performed under the homomorphic evaluation with no interaction.

A Protocol From One-Way Functions. Our focus is then on protocols that do not make use of FHE. Even more, we will focus on protocols that make use of as weaker cryptography assumptions as possible (preferably one-way functions, or no assumptions).

We provide a protocol that is resilient as long as t+s<n and t<n/2 and achieves security with abort. The protocol communicates O(poly (n, κ)) bits over the expensive channels and assumes the existence of one-way functions.

Theorem 7. Let n, s, t be natural numbers such that t+s<n and t<n/2. Assuming the existence of one-way functions, there is an asymmetric MPC protocol among n parties that securely evaluates circuit C with security with abort, in the presence of up to t malicious corruptions and s slow parties. The communication complexity is O(poly (n, κ)) bits of expensive communication and O(poly (n, κ)|C|) bits of cheap communication.

Interestingly, our communication-efficient protocol requires the existence of one-way functions, in contrast to our round-efficient protocols. We conjecture that this is necessary, and provide a partial result in this direction.

Lemma 1. Assume an n-party asymmetric MPC, secure up to t semi-honest corruptions and s slow parties such that the slow parties perform constant computation, for any n, s, t>0 natural numbers such that n−s>1, t+s<n and t<n/2. Then, this implies the existence of one-way functions.

### 3 Technical Overview

In this section we describe the techniques used to achieve our theorem statements.

3.1 Information-Theoretic MPC with Asymmetric Delays

We present several information-theoretic solutions for the settings of security with abort and guaranteed output delivery.

Security with Abort.

We provide a simple solution that achieves security with abort in a constant number of slow rounds, when t+s<n and t<n/2. The protocol lets all parties generate during a pre-processing phase OT correlations among the fast parties, using an information-theoretic MPC protocol for honest majority and security with abort, with round complexity linear in the depth of the circuit. Since the OTs can be generated in parallel and can be computed with a constant-depth circuit, this takes a constant number of slow rounds. Then, the parties execute an information-theoretic MPC protocol in the client-server model, that achieves security with abort against a dishonest majority in the OT-hybrid model: The parties (acting as clients) distribute their inputs to the fast parties (acting as servers), who will compute the corresponding outputs and send them back to the respective parties. Existing protocols run in a constant number of rounds during the input and output phases, and the number of rounds during the computation is linear in the depth of the circuit to evaluate. This leads to Theorem 1.

We then show that our protocol achieves the optimal resilience: any asymmetric MPC protocol secure when t+s=n among n parties and with constant number of slow rounds, implies a synchronous MPC protocol with security with abort, resilient up to 1 corruption in constant number of rounds, which is a major open problem in round complexity of MPC. The proof implication follows from a simple emulation argument: In order to design a synchronous MPC protocol among s+1 parties, we simply let s parties emulate each of the slow parties in the asymmetric MPC protocol, and the last party to emulate all fast parties altogether (in total t parties). The resulting synchronous protocol has a round-complexity that is the same as the number of slow rounds in the asymmetric MPC protocol, and therefore the implication follows. This corresponds to Theorem 2.

### Asymmetric Broadcast.

We briefly sketch the arguments that characterize the feasibility of asymmetric broadcast.

First observe that it is clear that for a sender that is a slow party, it is impossible to expect the fast parties to obtain output fast, even when all parties are honest. Therefore, we focus on the case where the sender is a fast party.

The protocol to achieve asymmetric broadcast (for a fast sender), for any 2t+s<n, assuming a PKI for signatures, is quite simple: Fast parties run a synchronous broadcast protocol among themselves, and reach agreement on a value ν. All fast parties send the value ν to the slow parties, who take a majority decision. Since there is honest majority among the fast parties, all slow parties output the same value. This is presented in

### Theorem 4.

In order to show that asymmetric broadcast (for a fast sender) is impossible when 2t+s=n, even with setup, we make use of two ideas. First, observe that fast parties must output before the slow parties are even able to communicate with any fast party. This is because fast rounds may be much faster than slow rounds, i.e., the delay δ«Δ of fast channels could be much smaller than the delay Δ of slow channels, and asymmetric broadcast requires fast parties to output fast. Let ν denote the value that the fast parties output. Second, since there is a dishonest majority among the fast parties, the corrupted parties (including the sender) can simulate towards the slow parties an execution with input value ν′+ν. As a consequence, the honest slow parties cannot decide on a consistent output value. A precise scenario-based proof is presented in Theorem 5.

### Guaranteed Output Delivery.

We present two results. We first present a somewhat simple solution for an information-theoretic protocol in the regime where 2t+s<n and t<n/3. The protocol works as follows: First, since t<n/3, the protocol generates a setup for information-theoretic signatures to emulate synchronous broadcast channels with guaranteed termination from slow parties to all parties in O(κ) slow rounds, and from fast parties to themselves in O(κ) fast rounds, where k is the security parameter. Using these broadcast channels, parties can execute an existing synchronous protocol in the client-server model as follows: All parties initially play the role of a client, while each fast party in addition plays the role of a server. The clients distribute their inputs towards the n-s servers, where each synchronous round corresponds to a slow round. The servers then perform the protocol computation, where each synchronous round corresponds to a fast round. Finally, the fast parties robustly reconstruct each output to the respective clients, where each synchronous round corresponds to a slow round. Standard information-theoretic protocols tolerate up to half of the corrupted servers (we assume 2t<n−s) and any number of clients, and have a constant number of rounds and broadcast invocations, during the input and the output phase, and a number of rounds proportional to the circuit depth during the computation phase. This results in an asymmetric MPC protocol with O(κ) slow rounds and a number of fast rounds proportional to the circuit depth times k, corresponding to Theorem 3.

We then present our information-theoretic asymmetric MPC protocol with guaranteed output delivery, and resilience t+s<n and t<n/2, which assumes asymmetric broadcast.

The protocol follows the sharing-based paradigm, and has a preprocessing phase and an online phase. During the preprocessing phase, the parties generate raw data that is independent of the inputs. During the online phase, the parties receive their inputs and perform the protocol evaluation.

In the preprocessing phase, we generate certified Beaver multiplication triples, using the MPC protocol by Cramer et. al.

Background Let us first recap their VSS protocol Πᵥₛₛ. The protocol follows traditional verifiable secret sharing schemes with bivariate polynomials, but uses so-called information-checking (IC) signatures, instead of error correction. Abstractly speaking, one can think about such signatures as information-theoretic signatures that can only be forwarded once. These can be generated unconditionally without setup, and also have a linearity property, where given signatures for values x and y, one can compute a signature on x+y.

In order to share a value ν, the dealer D creates a random bivariate polynomial f(x, y) of degree at most t, with f(0, 0)=ν. The univariate polynomial projections f(x, i) and f(i, y) are sent to party Pᵢ in a signed manner (by sending all the points (aᵢ₁, . . . , aᵢₙ)=(f(i, 1), . . . , f(i, n)) and (b₁ᵢ, . . . , bₙᵢ)=(f(1, i), . . . , f(n, i)), where each point is signed using IC-signatures). After this, the parties can bilaterally compare the cross-point values between them, and expose inconsistent behavior by the dealer by broadcasting the signatures. If an inconsistency is detected, the dealer is disqualified.

After the checking process, the values held by honest parties are consistent, and since there are at least n−t≥t+1 honest parties, these values uniquely define a bivariate polynomial f′(x, y) of degree at most t, which in turn defines a fixed secret ν′ (which is ν′=ν if the dealer is honest). Therefore, this already ensures that the dealer is committed to a value after the sharing phase.

Still, the reconstruction might fail if the adversary sends corrupted shares (the adversary can send arbitrary shares). In order to avoid that, each share of Pᵢ is also signed by the other parties. This will in turn prevent the adversary from corrupting the secret at reconstruction time.

At the end of the VSS, each party Pᵢ holds sub-shares (aᵢ₁, . . . , aᵢₙ), where aᵢⱼ is signed by Pⱼ. This implicitly defines a share aᵢ, which in the case of an honest dealer corresponds to f(i, 0).

With the above VSS scheme, one can process addition gates locally (using the fact that the IC-signatures are linear). The multiplication gates are processed using the well-known method by Gennaro, Rabin and Rabin: Each party Pᵢ locally multiplies his shares aᵢ and bᵢ of the input wires a and b, and shares the result dᵢ=aᵢbᵢ using VSS. This results in n VSSs and a proper sharing of the output wire c can be computed as a fixed linear combination of these. The authors show a way for Pᵢ to share a secret dᵢ, such that dᵢ=aᵢbᵢ and to prove that he has done so properly.

The Online Protocol. At the start of the online phase, enough triples (x, y, z) have been shared using the protocol described above, where each of the shares xᵢ, yᵢ, zᵢ are held (implicitly) by party Pᵢ via the corresponding sub-shares, which are IC-signed by the other parties. Note that generating such certified Beaver triples takes O(1) invocations of broadcast, since they can be generated in parallel.

The online phase proceeds as follows. Parties distribute their inputs using Πᵥₛₛ. The addition gates are locally computed (simply adding the shares and the IC-signatures, since they are linear). In the multiplication gates, fast parties publicly open two random values, (a−x) and (b−y), where a and b are the values of the input wires to the multiplication gate, by running the same reconstruction procedure of Π_{yss}, except that they distribute their shares using asymmetric broadcast. Since the values are IC-signed, corrupted fast parties can only withhold their shares. Since fast parties distribute their shares via the asymmetric broadcast channel, this implies that all parties, fast and slow, reach agreement on the set of parties that did not contribute their share and are corrupted.

Note that since the threshold is t<n−s, if all fast parties contribute their shares, the slow parties do not need to participate (and the protocol can proceed between between the fast parties, without incurring additional slow rounds). However, if not all shares are received, a process to identify and kick out corrupted parties is performed: fast parties wait for the slow parties to help opening the shares (note that n−t>t, and therefore all honest parties can jointly open the shares). The corrupted identified parties are then kicked out of the computation, and the protocol is restarted without the kicked parties. This process incurs and overhead of a constant number of slow asymmetric broadcast delays. And since every time at least one corrupted party is kicked out, the incurred overhead on the total number of slow rounds is linear in the number of parties. This corresponds to Theorem 6.

3.2 MPC with Asymmetric Communication Cost

We describe the protocol for MPC that communicates O(poly (n, κ)) bits over slow connections, and achieves resilience t+s<n and t<n/2. The protocol is based on one-way functions, and is similar to the simple protocol mentioned in Theorem 1 in the asymmetric delay model.

In that protocol, the step that is communication expensive, is the generation of the OT correlations, which depends on the circuit size. In order to solve that, we will make use of OT-extension protocols, which can be based on one-way functions.

More concretely, since t<n/2, parties can jointly create κ OT correlations among each pair of fast parties using an honest-majority MPC protocol. This step communicates O(poly(n, κ)) bits over slow connections. The fast parties then perform an OT-extension protocol to set up an OT channel between each pair of fast parties.

With this setup, parties can then perform an unconditional protocol achieving dishonest majority in the OT-hybrid model among the fast parties. The theorem stating the security of this protocol is Theorem 7.

The protocol described above makes use of one-way functions. We conjecture that this is necessary, and provide a partial result: we show that any asymmetric MPC protocol containing at least two fast parties, where the slow parties perform little computation, and with resilience t+s<n, implies the existence of one-way functions.

The high-level idea is to build an OT extension protocol from an asymmetric MPC protocol. Since OT extension implies the existence of one-way functions, the claim follows.

Assume that there is an asymmetric MPC protocol that outputs a large number of OTs. We can emulate the computation of each slow party using a protocol for dishonest majority. Note that since each slow party performs a small amount of computation, the circuit that is used to emulate the computation uses a small number of (seed) OTs as well. This is stated in Lemma 1.

### 4 Models and Definitions

We consider a set of n parties [symbol] ={P₁, . . . , Pₙ}. We partition the set of parties into two known categories, slow parties and fast parties, [symbol] = [symbol] ␣ [symbol] . We denote by k the security parameter.

### 4.1 Communication Network and Adversary

We consider a complete network of point-to-point secure channels. Parties have access to synchronized clocks, and messages sent by honest parties are guaranteed to be delivered within some known upper bound delay. We consider two asymmetric network models.

Network with Asymmetric Delays. In the first model, we consider a network with asymmetric delays. The channels between fast parties deliver messages within a small delay δ, and are denoted fast channels. And all channels containing at least one slow party have a large delay Δ, and are denoted slow channels. We measure the round complexity as the number of slow P2P-rounds (communication steps via all channels), and the number of fast P2P-rounds (communication steps via fast channels). We will omit mentioning the P2P term, and simply denote such rounds as fast and slow rounds.

Network with Asymmetric Communication Cost. In the second model, we consider a network with asymmetric communication cost. Here, all the channels have the same delay upper bound, similar to the standard synchronous network model, but the cost of communication is asymmetric. We will consider expensive communication, the number of bits transmitted via channels that contain at least one slow party, and cheap communication, the number of bits transmitted via channels that contain only fast parties.

Adversary. We consider a static adversary who corrupts parties in an arbitrary manner at the beginning of the protocol.

### 4.2 Broadcast

Broadcast allows a designated party called the sender to consistently distribute a message among a set of receivers.

Synchronous Broadcast. The synchronous broadcast channel with guaranteed termination delivers the output to the set of receivers after a fixed number of rounds. There are also protocols with probabilistic termination, where the parties obtain output after an expected-constant number of rounds. However, composing such protocols involves many subtleties. Synchronous broadcast protocols with guaranteed termination can be achieved within O(K) rounds, when there are up to a third fraction of corrupted parties. This is also the case for honest majority, if a setup is available. In the dishonest majority setting, synchronous broadcast is achievable in O(n) rounds with a PKI setup, and even unconditionally with a setup for information-theoretic signatures.

These protocols, when run in the asymmetric network delay model, achieve an actual number of rounds that is proportional to the slowest channel. This means, that if all the parties involved (sender and receivers) are connected via fast channels, the output is received after a fixed number of fast rounds. However, when some of the channels between the considered parties are slow, the protocols guarantee that the receivers obtain the output in a fixed number of slow rounds.

### 4.3 Secret Sharing

In some of our protocols, we make use of Shamir secret sharing scheme. This is a t-out-of-n linear secret-sharing scheme over a finite field [symbol] , consisting of two protocols, (Sh, Rec), called share and reconstruct.

Protocol Sh allows a designated party, called the dealer, to distribute a value s∈ [symbol] among n parties, P₁, . . . , Pₙ. For that, the dealer samples a uniform random polynomial f∈ [symbol] [x] with degree at most t, and subject to the fact that f(0)=s. Then, the dealer sends the value f(i)=sᵢ to Pᵢ. We denote sᵢ the share of Pᵢ, and the vector [s]ₜ=(s₁, . . . , sₙ) is called a degree-t sharing of s. We may omit the degree if it is clear from the context. Note that any set of t shares does not reveal anything about the secret.

Protocol Rec allows parties to jointly reconstruct a secret s′, which corresponds to the original secret s if the dealer is honest.

Shamir secret sharing scheme satisfies in addition the following properties:

$$Additive Homomorphism :$$

$$∀ {[ x ]}_{t} , {[ y ]}_{t} , {[ x + y ]}_{t} = {[ x ]}_{t} + {[ y ]}_{t} .$$

$$Local Multiplication of Degree - t Sharings :$$

$$∀ {[ x ]}_{t} , {[ y ]}_{t} , {[ x \cdot y ]}_{t} = {[ x ]}_{t} \cdot {[ y ]}_{t} .$$

### 4.4 Oblivious Transfer

Oblivious transfer is a two-party primitive between a sender S, and a receiver R. The sender has two inputs x₀, x₁∈{0, 1}, called the messages, and the receiver R has an input c∈{0, 1}, called the selection bit. The oblivious transfer guarantees that R outputs x_{c}=c(x₀⊕x₁)⊕x₀, and that no party learns any other information.

MPC with Asymmetric Delays

In this section we introduce protocols in the model with asymmetric delays. We are interested in protocols that incur as few slow rounds as possible, preferably a constant, and tolerating a high number of corruptions and slow parties.

5.1 Security with Abort

### Protocol Description.

We present a naive protocol that achieves security with abort in a constant number of slow rounds, when t+s<n and t<n/2.

The protocol lets all parties generate during a pre-processing phase OT correlations among the fast parties, using a (synchronous) information-theoretic MPC protocol for honest majority and security with abort, with round complexity linear in the circuit depth to evaluate. Note that since the OTs can be generated in parallel and can be computed with a constant-depth circuit, this is possible in a constant number of slow rounds. Then, the parties execute an information-theoretic MPC protocol in the client-server model, that achieves security with abort against a dishonest majority in the OT-hybrid model: All parties act as clients and distribute their inputs to the fast parties, who also act as servers. The fast parties will then compute the corresponding outputs and send them back to the respective parties. Existing protocols run in a constant number of rounds during the input and output phases, and the number of rounds during the computation is linear in the depth of the circuit to evaluate. As a consequence, the overall protocol incurs a constant number of slow rounds, and a number of fast rounds proportional to the depth of the circuit. This leads to the following theorem.

Theorem 1. Let n, s, t be natural numbers such that t+s<n and t<n/2. There is an information-theoretic asymmetric MPC protocol among n parties that securely evaluates circuit C with security with abort, in the presence of up to t malicious corruptions and s slow parties. The round complexity is O(1) slow rounds and O(depth(C)) fast rounds.

### Barrier Result.

Our result shows that improving the resiliency achieved by the protocols in the above sections would be a breakthrough in the area of information-theoretic synchronous MPC.

In particular, if there is an information-theoretic protocol that is constant in the number of slow rounds for t+s=n, this implies a constant-round information-theoretic synchronous MPC protocol secure up to 1 corruption.

Theorem 2. Let n, s, t>0 be natural numbers such that t+s=n. Then n-party information-theoretic asymmetric MPC with security with abort (resp. guaranteed output delivery), resilient up to t corruptions and s slow parties in R slow rounds, implies (s+1)-party information-theoretic synchronous MPC with security with abort (resp. guaranteed output delivery), resilient up to 1 corruptions in R rounds.
5.2 Broadcast with Asymmetric Delays

The asymmetric broadcast channel guarantees the delivery of a consistent message fast to the fast parties and slow to the slow parties. More precisely, an asymmetric broadcast channel achieves guaranteed output after D_{bc} slow rounds for slow parties, and die fast rounds for the fast parties. We will make use of this channel in the protocol for guaranteed output delivery with resilience t+s<n and t<n/2, but in this section we study the feasibility of this primitive from a complete network of point-to-point channels as a standalone question.

Functionality: [symbol] . On input x from the sender P*, output x to the adversary. Then, output x to all parties in [symbol] after D_{bc} slow rounds and all parties in [symbol] after d_{bc} fast rounds. First, note that when the sender is slow, it is impossible to achieve asymmetric broadcast, since one needs at least a slow round to distribute the value towards the fast parties. Therefore, in the following we focus on the more interesting case where the sender is a fast party.

Feasibility. Assuming setup, if 2t+s<n, it is easy to see that asymmetric broadcast with a fast sender is achievable. The protocol proceeds as follows: The sender with input s uses a synchronous broadcast protocol to distribute his value among all the fast parties. Since there is an honest majority of fast parties, one can for example use the protocol by Katz and Koo. All the fast parties reach agreement on a value s′ (which is s if the sender is honest) within O(κ) fast rounds, and they send their value to the slow parties, who will take a majority decision and output the result. Therefore, the slow parties output after O(κ) fast rounds, and 1 slow round.

Theorem 4. Let n, s, t be natural numbers such that 2t+s<n. Assuming a PKI setup for signatures, there is an n-party asymmetric broadcast protocol with d_{bc}=D_{bc}=O(κ), tolerating t malicious corruptions and s slow parties.

The protocol can be achieved with unconditional security, if a setup for information-theoretic signatures is assumed.

Impossibility. We show that asymmetric broadcast is impossible when 2t+s=n for a fast sender (even with setup), for any non-trivial parameters t>0 and s>0. Note that this is in contrast to synchronous broadcast, which is achievable for any number of corruptions assuming a PKI setup. (Or even unconditionally, assuming information-theoretic signatures.) The main challenge is to achieve agreement between fast and slow parties. Intuitively, since asymmetric broadcast requires fast parties to obtain the output fast, they need to decide their output value (let us denote it ν) without having received any value from the slow parties. Moreover, since there is dishonest majority among the fast parties, they can act towards the slow parties as if their output value was ν′≠ν. As a consequence, the honest slow parties will not output ν and consistency is broken.

Theorem 5. Let n, s, t>0 be natural positive numbers such that 2t+s=n. Then, asymmetric broadcast is impossible against t malicious corruptions and s slow parties, even with setup.

### 5.3 Guaranteed Output Delivery

In this section, we present two protocols. The first protocol achieves a lower resilience, but operates only assuming point-to-point channels. The second protocol has a higher resilience, but makes use of asymmetric broadcast.

Protocol for 2t+s<n and t<n/3.

In the regime where 2t+s<n and t<n/3, it is easy to design an asymmetric MPC protocol, by simply delegating the computation to the fast parties. Note that since t<n/3, the parties can create a setup of information-theoretic signatures, which can be used to construct a synchronous broadcast channel from slow parties to all parties in O(κ) slow rounds, and from fast parties among themselves in O(κ) fast rounds.

With the emulated synchronous broadcast channels, parties can then execute an honest majority protocol as follows: the slow parties, using the emulated broadcast channel, use a verifiable secret sharing scheme to share their input towards the fast parties (with threshold t), who will robustly evaluate the circuit among themselves. The fast parties can then robustly reconstruct the output towards the respective recipients. The total round complexity is O(κ) slow rounds and O(depth(C)·κ) fast rounds. The theorem follows.

Theorem 3. Let k be a security parameter. Let n, s, t be natural numbers such that 2t+s<n and t<n/3. There is an asymmetric MPC protocol among n parties that securely evaluates circuit C with guaranteed output delivery in the presence of up to t malicious corruptions and s slow parties. The round complexity is O(κ) slow rounds and O(depth(C)·κ) fast rounds.

We note that if a synchronous broadcast channel is given (or alternatively a setup for information-theoretic signatures), the condition t<n/3 is not necessary.

Protocol for t+s<n and t<n/2.

In this section, we present a protocol that achieves guaranteed output delivery with the higher trade-off t+s<n and t<n/2. The resulting protocol has round complexity O(n·D_{bc}) slow rounds and O(depth(C)·n·d_{bc}) fast rounds, assuming asymmetric broadcast.

Generating Certified Beaver Triples. We generate Beaver multiplication triples (a, b, c), that are shared among all parties. The triples are certified, in the sense that all shares are signed via information-checking signatures. There can be thought of as signatures that are information-theoretic, and can only be forwarded once. The signatures are also homomorphic, in the sense that for two values that can be verified by the scheme, any linear combination of them can also be verified with no additional information.

We generate the triples using the protocol by Cramer et al., which makes use of such a IC-signature scheme. The protocol takes O(1) invocations to asymmetric broadcast (incurring a total of O(D_{bc}) slow rounds), since the multiplication triples can be generated in parallel.

In this protocol, a value s is shared using a bivariate polynomial f(x, y) with degree at most t. At the end of the sharing protocol, each honest party Pᵢ holds the values sᵢ₁, . . . , sᵢₙ that lie on a degree-t polynomial, which in the case the dealer is honest, corresponds to the values f(i, 1), . . . , f(i, n). This implicitly defines the share of Pᵢ, which is sᵢ=f(i, 0). Moreover, each value sᵢⱼ is signed by party Pⱼ, and we denote such a signature (from Pⱼ to Pᵢ) by σ(sᵢⱼ, Pⱼ, Pᵢ). This signature allows Pᵢ to forward the value sᵢⱼ in an authentic way. In Section 7, we recap the protocol in detail.

The Online Phase. At the start of the online phase, enough triples (a, b, c) have been shared using the protocol in Cramer et al. This means, that each party Pᵢ implicitly holds each of the shares aᵢ, bᵢ, cᵢ via the corresponding sub-shares, which are signed by the other parties.

The online phase proceeds as follows. Parties distribute their inputs using Πᵥₛₛ, the VSS scheme in Cramer et al. The addition gates can locally computed (simply by locally adding the shares and locally adding the signatures, since they are linear). In the multiplication gates, fast parties robustly open two random values, (x−a) and (y−b), where x and y are the values of the input wires to the multiplication gate, by running the same reconstruction procedure of Πᵥₛₛ, except that they distribute their shares using asymmetric broadcast. Since the values are signed, corrupted fast parties can only withhold their shares. Since fast parties distribute their shares via the asymmetric broadcast channel, this implies that all parties, fast and slow, reach agreement on the set of parties that did not contribute their share and are corrupted.

Note that since the threshold is t<n−s, if all fast parties contribute their shares, the slow parties do not need to participate (and therefore we do not need to incur additional slow rounds). However, if not all shares are received, a process to identify and kick out corrupted parties is performed: fast parties wait for the slow parties to help opening the shares (note that n−t>t, and therefore all honest parties can jointly open the shares). The corrupted identified parties are then kicked out of the computation, and the protocol is restarted without the kicked parties. This process involves O(D_{bc}) slow rounds. And since every time at least one corrupted party is kicked out, the incurred total number of slow rounds is linear in the number of parties times the broadcast slow delay. We formally describe the protocol below.

Protocol: Π_{rgod}

Initialize t′=t, [symbol] = [symbol] .

### Preprocessing Phase

1: Parties use the protocol of Cramer et al. to create:
nₘ random sharings of certified Beaver triples ([aₖ], [bₖ], [cₖ]), where nₘ is the number of multiplication gates, as explained before. This means, that for each triple (a, b, c), each honest party Pᵢ implicitly holds his share aᵢ by holding sub-shares zᵢ₁, . . . , aᵢₙ, where each sub-share is IC-signed by Pⱼ. These sub-shares lie on a degree-t polynomial; and the shares aᵢ also lie on a degree-t polynomial f with f(0)=a. And similarly, for the values b and c=ab.
   Input Phase Let xⱼ be the input from party Pⱼ.
1: Pⱼ uses the protocol Πᵥₛₛ (described in Section 7) to share his input xⱼ.

### Addition Gates

1: Fast parties locally add the shares using linearity of the sharing scheme, and compute the corresponding IC-signatures using its linearity property.
   Multiplication Gates Let [x] and [y] be sharings of the inputs to the gate.
1: Fast parties in [symbol] use a multiplication triple ([a], [b], [c]) to publicly reconstruct the values x−a and y−b among the fast parties, using the reconstruction procedure of Πᵥₛₛ (where only the fast parties start). That is, the fast parties use asymmetric broadcast to distribute their share towards all parties, and the corresponding IC-signatures.
2: After time d_{bc}, all the fast parties reach agreement on whether all the shares received have correct IC-signatures are t-consistent. If not, they keep waiting for a total of 2D_{bc} time. Otherwise, execute Step 5.
3: After time D_{bc}, all slow parties reach agreement on whether the shares distributed by the fast parties were correct (t-consistent and with correct signatures). If not, slow parties participate in the reconstruction by broadcasting their shares and IC-signatures.
4: After time 2D_{bc}, either there were enough shares to reconstruct at Step 2, or all honest parties (fast and slow) identify at least one corrupted fast party Pₖ∈ [symbol] that did not contribute its share. In this case, parties kick out the identified corrupted party, and restart the protocol, now with threshold t′=′−1, and set [symbol] = [symbol] \{Pₖ}.
5: Fast parties in [symbol] locally compute a share of the output to the gate as [z]=(x−a)[b]+(y−b)[a]+[c]+(x−a)(y−b) (via locally adding each of the sub-shares), and update the IC-signatures accordingly using the linearity property.

### Output Phase

1: To reconstruct a sharing [x] towards Pⱼ, parties robustly reconstruct the secret to the Pⱼ, using the VSS reconstruction protocol in Πᵥₛₛ.
   Theorem 6. Let n, s, t be natural numbers such that t+s<n and t<n/2. Assuming asymmetric broadcast with slow and fast delays D_{bc} and d_{bc}, Π_{rgod} is an asymmetric MPC protocol among n parties that securely evaluates circuit C with guaranteed output delivery, in the presence of up t corruptions and s slow parties. The round complexity is O(n·D_{bc}) slow rounds and O(depth(C)·n·d_{bc}) fast rounds. In the optimistic case where no party is corrupted, the round complexity is O(D_{bc}) slow rounds and O(depth(C)·d_{bc}) fast rounds.

Although the number of slow rounds is independent of the depth of the circuit, it has the drawback that it depends on the number of parties in the worst case. However, if we assume that among the fast parties there is a constant fraction of parties that are honest, then we can modify the above protocol to achieve round complexity O(D_{bc}) slow rounds and O(depth(C)·d_{bc}) fast rounds. Then, the adversary needs ∈(n−s) corrupted parties to not send messages in order to execute Steps 3 and 4 in a multiplication step, which will be all identified and kicked out of the computation. This can only happen at most 1/∈ times.

Corollary 1. Let ∈>0 and n, s, t be natural numbers such that t<min {(1−∈)(n−s), n/2}. Assuming asymmetric broadcast with slow and fast delays D_{bc} and d_{bc}, there is an asymmetric MPC protocol among n parties that securely evaluates circuit C with guaranteed output delivery, in the presence of up to t corruptions and s slow parties. The round complexity is O(D_{bc}) slow rounds and O(depth(C)·d_{bc}) fast rounds.
6 MPC with Asymmetric Communication Cost

In this section we introduce protocols in the model with asymmetric communication cost. We are interested in protocols that transmit as few bits as possible over expensive channels (channels containing at least one slow party), and that tolerate a high number of corrupted parties and slow parties.

Looking closer, our protocol from Theorem 3 already achieves small expensive communication, independent of the circuit since expensive communication only occurs in the input and output stages. However, the resiliency is only 2t+s<n. Therefore, we turn our attention to protocols achieving resiliency t+s<n and t<n/2.

6.1 Security with Abort

We provide a protocol that achieves security with abort and communicates O(poly(n, κ)) bits over the expensive channels. The protocol assumes the existence of one-way functions, and follows from existing results. The idea is to generate pair-wise OT correlations among the fast parties during a pre-processing phase. This is possible since there is an honest majority t<n/2 of parties, and the total number of communicated bits over expensive channels is independent of the circuit size. More concretely, all parties will prepare κ OT correlations per fast connection (in total O(n²κ) OTs. This can be reduced to O(nκ) OTs if there is a constant fraction of honest fast parties, i.e. t<(1−∈)(n−s), for ∈>0 constant, using the results of Harnik, Ishai and Kushilevitz, which combines from distributing computations among several committees from Bracha, techniques for combining oblivious transfers from Harnik et al., and constructions of dispersers). Each pair of fast parties can then use OT extension protocols to set up OT channels between them.

Once the OT channels are prepared, we can execute a standard unconditional OT-based protocols for dishonest majority to perform the computation among the fast parties, and deliver the outputs to all the parties, leading to the following theorem statement.

Theorem 7. Let n, s, t be natural numbers such that t+s<n and t<n/2. Assuming the existence of one-way functions, there is an asymmetric MPC protocol among n parties that securely evaluates circuit C with security with abort, in the presence of up to t malicious corruptions and s slow parties. The communication complexity is O(poly (n, κ)) bits of expensive communication and O(poly (n, κ)|C|) bits of cheap communication.

### 6.2 Barriers on Communication Complexity

In this section, we show that if one assumes an asymmetric MPC, where the slow parties perform a small amount of computation, then this implies OT extension.

Lemma 1. Assume an n-party asymmetric MPC, secure up to t semi-honest corruptions and s slow parties such that the slow parties perform constant computation, for any n, s, t>0 natural numbers such that n−s>1, t+s<n and t<n/2. Then, this implies the existence of one-way functions.
7 Preprocessing Phase of Protocol Π_{rgod}

In this section, we describe the details of the preprocessing phase of the protocol Π_{rgod} in Section 5.3, which uses the protocol by Cramer et al.

### 7.1 Information-Checking

Information checking (IC) is a tool for authenticating data that is information-theoretic. An IC scheme consists of the following protocols among three parties (called the dealer D, the intermediary INT and the receiver R):
Dist: The dealer with input s, sends s to INT and and some auxiliary information to INT and R.
AuthVal: INT (with input s), ensures that R will output s in protocol Reveal.
Reveal: R receives a value s′ from INT with some auxiliary data, and either accepts s′ or rejects.
   Definition 1. An IC scheme is a triple of protocols (Dist, AuthVal, Reveal) among parties D, INT, R, where D starts with an input s in Dist and R outputs a value in Reveal, that satisfy the following properties with overwhelming probability:
Correctness:
   If D, INT and R are honest, and D has input s in Dist, then R outputs s in Reveal.
   If INT and R are honest, then after executing Dist and AuthVal, INT outputs a value s such that if Reveal is executed, R outputs s.
   If D and R are honest, and D has input s in Dist, then R does not output s′≠s in Reveal.
Privacy: R has no information about the secret s after Dist.
Linearity: Let s₁ and s₂ be input values of D so that D, INT and R executed Dist and AuthVal on both inputs. Then, with no interaction, parties can locally emulate an execution with input s₁+s₂.
   IC-Signatures Later, we make use of information checking among n parties P₁, . . . , Pₙ. Protocol Dist will be carried out by the dealer D with intermediary INT and the receivers P₁, . . . , Pₙ, each with the same input value s. The information sent by D to INT will be called an IC-signature and we denote such a signature as σ(s, D, INT).

In order to verify a signature among n parties, the AuthVal protocol is executed bilaterally by INT and each party Pᵢ. Then, in protocol Reveal, INT broadcasts s and the authentication information, and if t+1 parties accept s then we say that the signature has been confirmed.

These signatures enable D to give INT a signature which only INT can use to convince the other parties about the authenticity of a value received from the dealer. Therefore, we can use these IC-signatures as signatures given specifically from D to INT, so that INT can prove authenticity of a received value to any party.

### 7.2 Verifiable Secret Sharing

We recall the definition of verifiable secret sharing (VSS).

Definition 2. A t-secure VSS scheme for sharing a secret s∈ [symbol] is a pair (Sh, Rec) n-party protocols that satisfy the following properties, even in the presence of an adversary corrupting up to t parties:
Correctness: Once all honest parties terminate protocol Sh, there exists a fixed value, s′∈ [symbol] ␣⊥, such that the following requirements hold:
   If the dealer D is honest, then s′=s, and each honest party outputs s′ in protocol Rec.
   If the dealer is corrupted then each honest party outputs s′ in protocol Rec.
Privacy: If the dealer is honest and no honest party has yet started Rec, then the adversary has no information about the shared secret s.
Termination: If the dealer D is honest then all honest parties terminate Sh, and if the honest parties invoke Rec, then each honest party eventually terminates Rec.

### Protocol Description.

The protocol is based on classical protocols, but using IC-signatures, instead of error correction.

In order to share a value s, the dealer D will make use of a bivariate polynomial f(x, y) of degree at most t. The projections f(x, i) and f(i, y) will be sent to party Pᵢ (where all the points are signed using IC-signatures). The parties can now bilaterally compare the cross-point values between them, and expose inconsistent behavior by the dealer using the signatures. This implies that the values held by honest parties are consistent, and since there are at least n−t>t+1 honest parties, these values uniquely define a bivariate polynomial f′(x, y) of degree at most t, which in turn defines the secret. Therefore, this already ensures that the dealer is committed to a value after the sharing phase.

However, the reconstruction might still fail if the adversary sends corrupted shares. In order to avoid that, each share of Pᵢ is also signed by the other parties. This will in turn prevent the adversary from corrupting the secret at reconstruction time.

### Protocol: Πᵥₛₛ

Share Let s be the input for the dealer D.
1: D chooses a random bivariate polynomial f(x, y) of degree at most t in each variable, such that f(0,0)=s. Let sᵢⱼ=f(i, j). The dealer sends to party Pᵢ the values a₁ᵢ=s₁ᵢ, . . . , aₙᵢ=sₙᵢ and bᵢ₁=sᵢ₁, . . . , bᵢₙ=sᵢₙ. For each value aⱼᵢ, bᵢⱼ, D attaches IC-signatures σ(aⱼᵢ, D, Pᵢ), and σ(bᵢⱼ, D, Pᵢ).
2: Party Pᵢ checks that the two sets a₁ᵢ, . . . , aₙᵢ and bᵢ₁, . . . , bᵢₙ are t-consistent. If the values are not t-consistent, Pᵢ broadcasts these values with D's signature on them. If a party hears a broadcast of inconsistent values with the dealer's signature then D is disqualified and execution is halted.
3: Pᵢ sends aⱼᵢ and a signature which he generates on aᵢⱼ, σ(aⱼᵢ, Pᵢ, Pⱼ) privately to Pⱼ.
4: Party Pᵢ compares the value aᵢⱼ which he received from Pⱼ in the previous step to the values bᵢⱼ received from D. If there is an inconsistency, Pᵢ broadcasts bᵢⱼ and σ(bᵢⱼ, D, Pᵢ).
5: Party Pᵢ checks if P; broadcasted a value bⱼᵢ, σ(bⱼᵢ, D, Pⱼ) which is different than the value aⱼᵢ which he holds. If such a broadcast exists then Pᵢ broadcasts dⱼᵢ and σ(aⱼᵢ, D, Pᵢ).
6: If for an index pair (i, j) a party hears two broadcasts with signatures from the dealer on different values, then D is disqualified and execution is halted.

### Reconstruct

1: Party Pᵢ broadcasts the values bᵢ₁, . . . , bᵢₙ with the signature for value bᵢⱼ which he received from party Pⱼ.
2: Party Pᵢ checks whether Pⱼ's shares broadcasted in the previous step are t-consistent and all the signatures are valid. If not then Pⱼ is disqualified.
3: The values of all non-disqualified parties are taken and interpolated to compute the secret.

### 7.3 Multi-Party Computation

Using the VSS scheme Πᵥₛₛ from above, it is possible to come up with an MPC protocol.

### Addition Gates.

Addition gates are straightforward and parties can process them locally (using the fact that the IC-signatures are linear).

### Multiplication Gates.

The multiplication gates are processed using the well-known method by Gennaro, Rabin and Rabin: Each party Pᵢ locally multiplies his shares aᵢ and bᵢ of the input wires a and b, and shares the result dᵢ=aᵢbᵢ using VSS. This results in n VSSs and a proper sharing of the output wire c can be computed as a fixed linear combination of these.

### 8 Network Factors

The system can be configured to identify the set of fast parties and the set of slow parties, wherein channels between fast parties have a relatively small delay, and channels that contain at least one slow party have a relatively large delay.

As used herein, when discussing the speed of a computing device's connection to a network, the terms “faster” and “slower” are often used to describe the rate at which data can be transferred between the device and the network. A device with a “faster” connection can send and receive data more quickly than a device with a “slower” connection. Several factors contribute to the speed of a network connection:
1. Bandwidth: Bandwidth refers to the maximum amount of data that can be transmitted over a network connection in a given time period, typically measured in bits per second (bps). A higher bandwidth allows more data to be transferred simultaneously, resulting in a faster connection. For example, a 100 Mbps Ethernet connection has a higher bandwidth and is considered faster than a 10 Mbps Ethernet connection.
2. Latency: Latency is the time it takes for a packet of data to travel from the source device to the destination device and back, often measured in milliseconds (ms). Lower latency means that data can be exchanged more quickly between the device and the network, resulting in a faster connection. Latency can be affected by factors such as the physical distance between devices, the number of network hops, and the processing time of network equipment.
3. Network technology: Different network technologies have varying speed capabilities. For example, a device connected to a network using a modern Wi-Fi standard like Wi-Fi 6 (802.11ax) will generally have a faster connection than a device using an older standard like Wi-Fi 4 (802.11n). Similarly, a device connected to a network via a wired Gigabit Ethernet connection will typically have a faster connection than a device using a wireless connection or an older Ethernet standard.
4. Network infrastructure: The quality and capacity of the network infrastructure, including routers, switches, and cabling, can impact connection speed. A well-designed and maintained network with high-quality components can provide faster connections compared to a poorly designed or outdated network.
5. Device hardware: The computing device's hardware, such as its network interface card (NIC), processor, and memory, can also affect the speed of its network connection. A device with a high-performance NIC and sufficient processing power can handle network traffic more efficiently, resulting in a faster connection.

To determine if one device has a faster connection than another, the system can use various tools and methods to measure the bandwidth, latency, and overall performance of each device's network connection. These include:
1. Speed tests: Online speed testing tools can measure the download and upload speeds of a device's connection to a remote server, providing an estimate of the available bandwidth.
2. Ping tests: Ping is a command-line tool that measures the round-trip time (latency) between a device and a specified network destination.
3. Network monitoring tools: Software applications like Wireshark or SolarWinds Network Performance Monitor can provide detailed insights into network traffic, helping to identify bottlenecks and performance issues that may impact connection speed.

By considering these factors and using appropriate testing methods, the system can be configured to determine whether one computing device has a faster network connection compared to another device.

When evaluating the speed of a network connection, one key factor to consider is delay, also known as latency. Delay refers to the amount of time it takes for a unit of data, typically a packet, to travel from the source device to the destination device across the network. A connection with lower delay is considered “faster,” while a connection with higher delay is considered “slower.”

Several factors contribute to the delay experienced by data packets traversing a network:
1. Propagation delay: This is the time it takes for a signal to travel through the physical medium (e.g., copper wire, optical fiber, or air) from the source to the destination. Propagation delay is determined by the distance between the devices and the speed at which the signal travels through the medium. For example, in copper wire, signals travel at approximately ⅔ the speed of light, while in optical fiber, they travel at nearly the speed of light.
2. Transmission delay: Transmission delay is the time it takes for a device to push all the bits of a packet onto the network medium. This delay depends on the size of the packet and the bandwidth of the network link. A higher bandwidth link can transmit packets more quickly, reducing transmission delay.
3. Processing delay: Each network device (e.g., routers and switches) along the path between the source and destination must process incoming packets, determine the appropriate outgoing interface, and queue the packets for transmission. The time taken for these tasks contributes to the overall delay. More powerful network devices with faster processors and more efficient algorithms can reduce processing delay.
4. Queuing delay: When packets arrive at a network device faster than they can be processed and transmitted, they are placed in a queue. The time a packet spends waiting in the queue is the queuing delay. Queuing delay can vary depending on the network load and the capacity of the network devices. When a network is congested, queuing delay can increase significantly.
5. Serialization delay: Serialization delay is the time it takes to encode and decode data packets at the source and destination devices. This includes the time required to convert parallel data from the device's computer bus into a serial format suitable for transmission over the network, and vice versa.

To measure the delay between two devices on a network, the system can be configured to use the ping command. Ping sends a small packet (usually an ICMP Echo Request) from the source device to the destination device and measures the time it takes for the destination to send a response (an ICMP Echo Reply) back to the source. This round-trip time (RTT) includes the propagation, transmission, processing, queuing, and serialization delays in both directions.

For example, if the system is configured to ping a remote server and the average RTT is 50 milliseconds (ms), this means that it takes 25 ms for a packet to travel from a first device to the server and another 25 ms for the response to travel back. A lower RTT indicates a faster connection with lower delay.

Other tools and protocols, such as Traceroute and TWAMP (Two-Way Active Measurement Protocol), can be used by the system to provide more detailed information about the delay encountered at each hop along a network path.

When comparing the speed of two network connections based on delay, the connection with consistently lower RTTs and less variability in delay (known as jitter) can be considered faster. However, the system can consider other factors, such as bandwidth and packet loss, to gain an understanding of network performance.

### 9 System Implementations

In some aspects, the present disclosure relates to methods and systems for asymmetric multi-party computation (MPC). More specifically, the disclosure may provide techniques for efficient computation among a set of distributed computerized processors, which are categorized into fast parties and slow parties based on their network connection speeds. The methods and systems described herein may leverage the advantages of both fast and slow parties to optimize the overall computation process.

In some cases, the methods and systems may involve a pre-processing phase where fast parties perform an oblivious transfer (OT)-extension protocol to set up an OT channel between each pair of fast parties. This process generates correlated randomness for the fast parties, enhancing the security and efficiency of the computation. The methods and systems may also include storing a set of inputs at both the slow and fast parties, executing a standard unconditional OT-based protocol for dishonest majority at each of the fast parties, and transmitting the output to the slow parties.

In some embodiments, the total number of communicated bits over channels with relatively larger delay, often associated with slow parties, is independent of the circuit size. This feature may provide a substantial advantage in scenarios where network bandwidth is limited or expensive. Furthermore, the slow parties may not perform the executable instructions, thereby reducing their computational load and potentially improving the overall efficiency of the system.

In other embodiments, the correlated randomness may be generated using an honest-majority MPC protocol or by a trusted dealer distributing a predetermined number of OT correlations among the fast parties directly. These techniques may further enhance the security and efficiency of the computation process.

The methods and systems described herein may provide a novel approach to asymmetric multi-party computation, offering potential benefits in terms of computational efficiency, network resource utilization, and security. These benefits may be particularly valuable in distributed computing environments where network resources and computational capabilities vary among different parties.

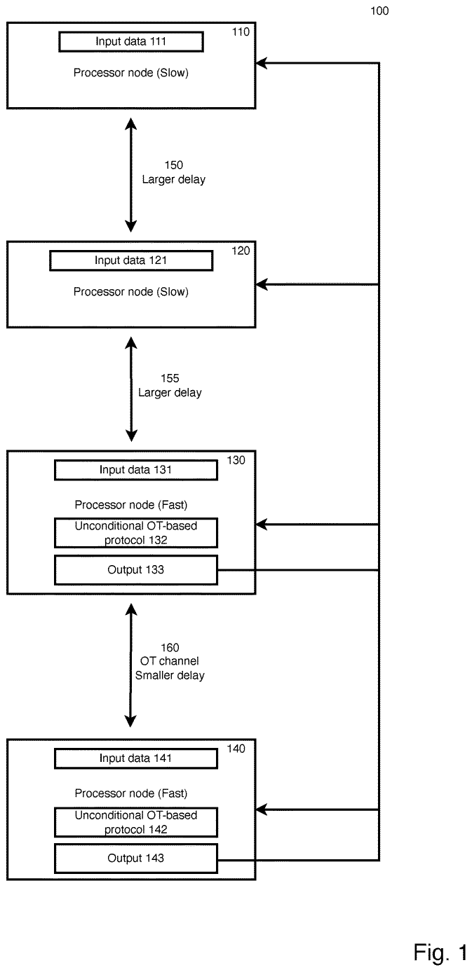

Referring to FIG. 1, an asymmetric multi-party computation system is depicted, involving multiple processor nodes. In some aspects, the system includes a processor node 110, labeled as “slow,” which receives input data 111 and is connected via a channel with a larger delay 150. Similarly, another processor node 120, also labeled as “slow,” receives input data 121 and is connected via a channel with a larger delay 155. These slow processor nodes may have a slower network connection or lower computational resources compared to other nodes in the system.

In some cases, the system also includes processor node 130, labeled as “fast,” which receives input data 131 and executes an unconditional OT-based protocol 132 to generate output 133. This node is connected via an OT channel 160 characterized by a smaller delay, indicating a faster network connection or higher computational resources. Another processor node 140, also labeled as “fast,” receives input data 141, executes an unconditional OT-based protocol 142, and generates output 143.

In some embodiments, the output 133 and output 143 are distributed over any channel to all of the other nodes in the system. This distribution may be performed in a manner that minimizes the total number of communicated bits over expensive channels, which are independent of the circuit size. In some cases, the slow parties do not perform the executable instructions, thereby reducing their computational load and potentially improving the overall efficiency of the system.

In some aspects, the correlated randomness for the fast parties may be generated using an honest-majority MPC protocol or by a trusted dealer distributing a predetermined number of OT correlations among the fast parties directly, where the number of correlations is a security parameter. In some cases, the slow players are responsible for generating the MPC correlations. This configuration allows for a flexible and efficient computation process that can accommodate varying network conditions and computational resources among the participating nodes.

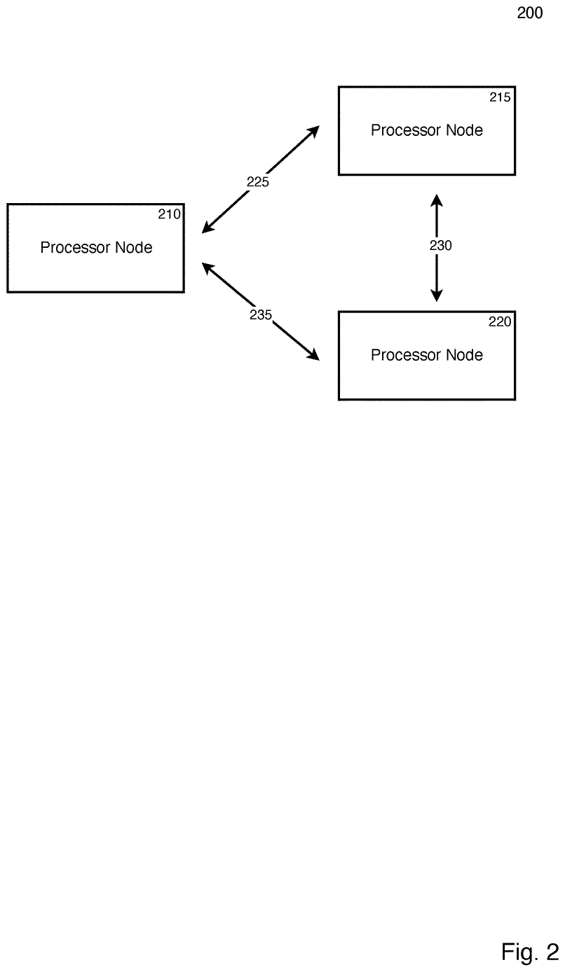

FIG. 2 is a block diagram of a system 200 in which the techniques and principles described herein may be implemented. The system 200 comprises a plurality of processor nodes 210, 215, 220, with three processor nodes being shown in FIG. 2. Each processor node is able to participate in multiparty computations (MPCs), with one or more of the other processor nodes. As described herein, multiparty computation techniques allow the computation of a joint function on sensitive (private) inputs from mutually distrusting parties without requiring those parties to disclose these inputs to a trusted third party or to each other (thus preserving the privacy of these inputs). Cryptographic protocols ensure that no participating party (or coalition of parties) learns anything from this computation except its intended part of the computation outcome. In the system shown in FIG. 2, an input for the computation can be provided by one or more processor nodes and/or by one or more input nodes (not shown in FIG. 2). The output of the computation may be returned to the node that provided the input(s), e.g. one or more processor nodes and/or one or more input nodes, and/or the output can be provided to one or more nodes that did not provide an input, e.g. one or more of the other processor nodes and/or one or more output nodes (not shown in FIG. 2). Often, a recipient of the output of the MPC is a node that requested the computation.

The plurality of processor nodes in FIG. 2 can be considered as a “committee” of processor nodes that can perform an MPC. A single committee may perform the whole MPC, but in some cases multiple committees (comprising a respective plurality of processor nodes) can perform respective parts of the MPC.

The processor nodes are interconnected and thus can exchange signalling therebetween (shown as signals 225, 230, 235). The processor nodes may be local to each other, or one or more of the processor nodes may be remote from the other processor nodes. In that case, the processor nodes may be interconnected via one or more wireless or wired networks, including the Internet and a local area network. As discussed above, these interconnections may be of varying network resources. For example, some of the interconnections may utilize high-end network resources (e.g. channels with small delay, cheap channels, etc.).

Each processor node can be any type of electronic device or computing device. For example a processor node can be, or be part of any suitable type of electronic device or computing device, such as a server, computer, laptop, smart phone, etc. It will be appreciated that the processor nodes shown in FIG. 2 do not need to be the same type of device, and for example, one or more processor nodes can be servers, one or more processor nodes can be a desktop computer, etc.

Referring to FIG. 2, a schematic representation of a networked system with multiple processor nodes is depicted. In some aspects, processor node 210 is connected to processor node 215 via a communication link 225. This connection indicates a pathway for data exchange or communication between these nodes. In some cases, processor node 215 is further connected to processor node 220 through another communication link 235. This connection establishes a network configuration where processor node 220 can communicate with both processor node 210 and processor node 215. This forms a triangular communication topology, which may provide efficient data exchange among the processor nodes.

In some embodiments, the triangular communication topology among the processor nodes may be utilized to optimize the data flow and reduce the communication delay. This configuration may be particularly beneficial in scenarios where the processor nodes have varying computational resources or network conditions. The use of multiple communication links, such as communication link 225 and communication link 235, may allow for parallel data transmission and reception, potentially enhancing the overall performance of the multi-party computation process.

In some cases, additional communication links, such as communication link 230, may be established between other pairs of processor nodes to further enhance the network configuration. These additional communication links may provide alternative pathways for data exchange, thereby increasing the robustness and flexibility of the networked system.

It is to be understood that the specific arrangement and number of processor nodes and communication links depicted in FIG. 2 are merely illustrative. In other embodiments, the networked system may include more or fewer processor nodes and communication links arranged in different topologies, depending on the specific requirements of the multi-party computation process.

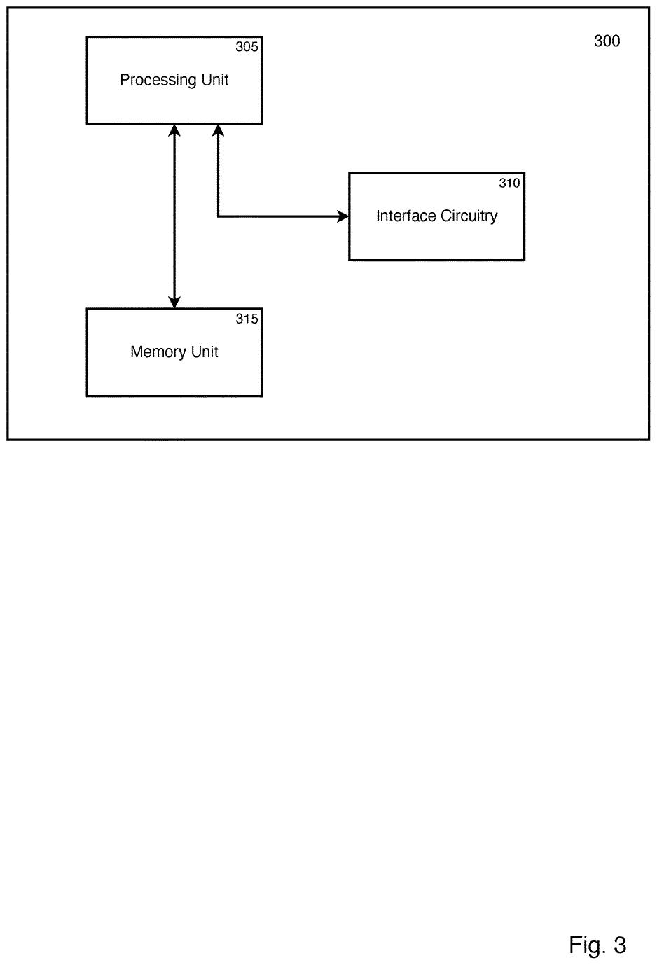

FIG. 3 is a block diagram of an exemplary processor node. The processor node 300 includes interface circuitry 310 for enabling a data connection to other devices or nodes, such as other processor nodes. In particular the interface circuitry can enable a connection between the processor node and a network, such as the Internet or a local area network, via any desirable wired or wireless communication protocol. The processor node further includes a processing unit 305 for performing operations on data and for generally controlling the operation of the processor node. The processor node further includes a memory unit 315 for storing any data required for the execution of the techniques described herein and for storing computer program code for causing the processing unit to perform method steps as described in more detail below.

Referring to FIG. 3, a block diagram of a computing device's core components is presented. In some aspects, the computing device includes a processing unit 305, interface circuitry 310, and a memory unit 315.

The processing unit 305, depicted as the central element, may be responsible for executing instructions and processing data. The processing unit 305 may be implemented in numerous ways, such as a microprocessor, a central processing unit, or a specialized processing device like an application-specific integrated circuit (ASIC), a field-programmable gate array (FPGA), a digital signal processor (DSP), or a network processor. The processing unit 305 may be configured to execute a set of executable instructions having a predetermined size, which may be stored in the memory unit 315. The processing unit can be implemented in numerous ways, with software and/or hardware, to perform the various functions described herein. The processing unit may comprise one or more microprocessors or digital signal processor (DSPs) that may be programmed using software or computer program code to perform the required functions and/or to control components of the processing unit to effect the required functions. The processing unit may be implemented as a combination of dedicated hardware to perform some functions (e.g. amplifiers, pre-amplifiers, analog-to-digital convertors (ADCs) and/or digital-to-analog convertors (DACs)) and a processor (e.g., one or more programmed microprocessors, controllers, DSPs and associated circuitry) to perform other functions. Examples of components that may be employed in various embodiments of the present disclosure include, but are not limited to, conventional microprocessors, DSPs, application specific integrated circuits (ASICs), and field-programmable gate arrays (FPGAs).

The memory unit 315 can comprise any type of non-transitory machine-readable medium, such as cache or system memory including volatile and non-volatile computer memory such as random access memory (RAM) static RAM (SRAM), dynamic RAM (DRAM), read-only memory (ROM), programmable ROM (PROM), erasable PROM (EPROM), and electrically erasable PROM (EEPROM). If a processor node stores or holds one or more data sets that can be processed in a multiparty computation, the data set(s) can be stored in the memory unit. The memory unit 315 is illustrated as the storage component for holding data and executable instructions. The memory unit 315 may include various types of storage media, such as random-access memory (RAM), read-only memory (ROM), flash memory, or other types of non-volatile memory. In some embodiments, the memory unit 315 may store a set of executable instructions having a predetermined size, which may be accessed and executed by the processing unit 305.

The interface circuitry 310 is shown as the component that facilitates data communication with other devices or networks. In some cases, the interface circuitry 310 may enable a connection between a plurality of distributed computerized processors. This connection may be established via various communication protocols, including wired or wireless connections, and may involve different types of networks such as local area networks (LANs), wide area networks (WANs), or the Internet.

The diagram in FIG. 3 indicates the foundational relationship between these elements, where the processing unit 305 utilizes the memory unit 315 to access instructions and data, while the interface circuitry 310 enables external communication. This configuration may provide a flexible and efficient platform for performing various operations, including those involved in asymmetric multi-party computation.

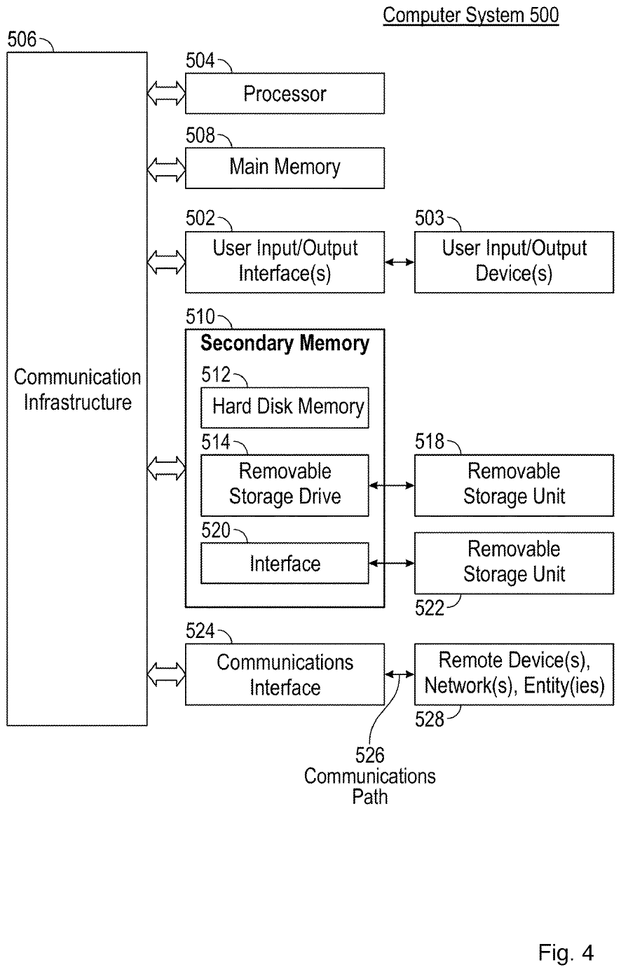

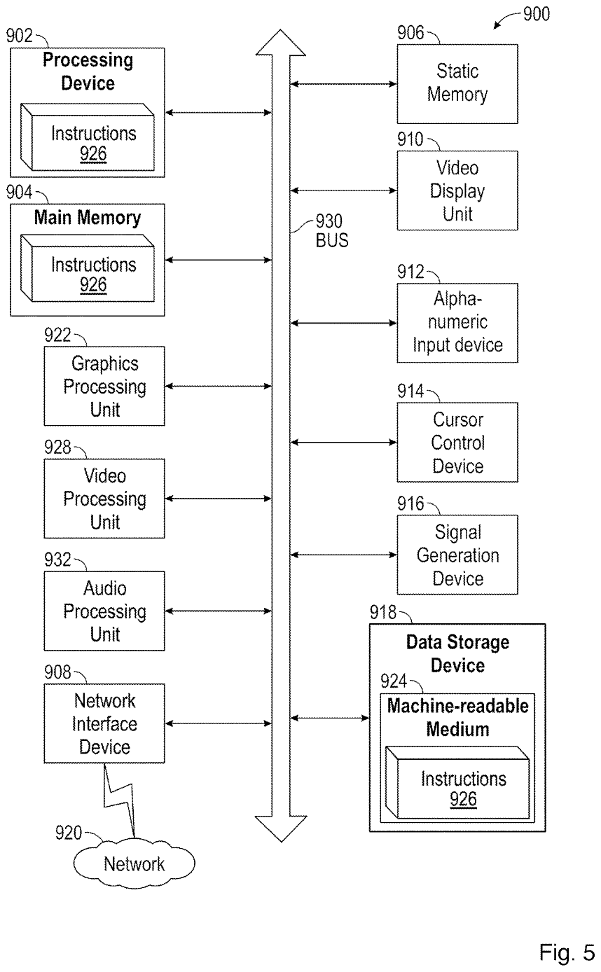

FIGS. 4 and 5 depict example computer systems useful for implementing various embodiments described in the present disclosure. Various embodiments may be implemented, for example, using one or more computer systems, such as computer system 500 shown in FIG. 4. One or more computer system(s) 500 may be used, for example, to implement any of the embodiments discussed herein, as well as combinations and sub-combinations thereof.

Computer system 500 may include one or more processors (also called central processing units, processing devices, or CPUs), such as a processor 504. Processor 504 may be connected to a communication infrastructure 506 (e.g., such as a bus).

Computer system 500 may also include user input/output device(s) 503, such as monitors, keyboards, pointing devices, etc., which may communicate with communication infrastructure 506 through user input/output interface(s) 502. One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main memory 508, such as random-access memory (RAM). Main memory 508 may include one or more levels of cache. Main memory 508 may have stored therein control logic (i.e., computer software, instructions, etc.) and/or data. Computer system 500 may also include one or more secondary storage devices or secondary memory 510. Secondary memory 510 may include, for example, a hard disk drive 512 and/or a removable storage device or removable storage drive 514.

Removable storage drive 514 may interact with a removable storage unit 518. Removable storage unit 518 may include a computer-usable or readable storage device having stored thereon computer software (control logic) and/or data. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities, or other approaches may include, for example, a removable storage unit 522 and an interface 520. Examples of the removable storage unit 522 and the interface 520 may include a program cartridge and cartridge interface, a removable memory chip (such as an EPROM or PROM) and associated socket, a memory stick and USB port, a memory card and associated memory card slot, and/or any other removable storage unit and associated interface.

Computer system 500 may further include communications interface 524 (e.g., network interface). Communications interface 524 may enable computer system 500 to communicate and interact with any combination of external devices, external networks, external entities, etc. (individually and collectively referenced as remote device(s), network(s), entity(ies) 528). For example, communications interface 524 may allow computer system 500 to communicate with external or remote device(s), network(s), entity(ies) 528 over communications path 526, which may be wired and/or wireless (or a combination thereof), and which may include any combination of LANs, WANs, the Internet, etc. Control logic and/or data may be transmitted to and from computer system 500 via communications path 526.

Computer system 500 may also be any of a personal digital assistant (PDA), desktop workstation, laptop or notebook computer, netbook, tablet, smartphone, smartwatch or other wearable devices, appliance, part of the Internet-of-Things, and/or embedded system, to name a few non-limiting examples, or any combination thereof.

Computer system 500 may be a client or server computing device, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

FIG. 5 illustrates an example machine of a computer system 900 within which a set of instructions, for causing the machine to perform any one or more of the operations discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, a specialized application or network security appliance or device, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a data storage device 918, which communicate with each other via a bus 930.

Processing device 902 represents one or more processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field-programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910, an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable medium 924 (also known as a computer-readable storage medium) on which is stored one or more sets of instructions 926 (e.g., software instructions) embodying any one or more of the operations described herein. The instructions 926 may also reside, completely or at least partially, within the main memory 904 and/or within the processing device 902 during execution thereof by the computer system 900, where the main memory 904 and the processing device 902 also constitute machine-readable storage media.

In an example, the instructions 926 include instructions to implement operations and functionality corresponding to the disclosed subject matter. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions 926. The term “machine-readable storage medium” shall also be taken to include any medium that is capable of storing or encoding a set of instructions 926 for execution by the machine and that cause the machine to perform any one or more of the operations of the present disclosure. The term “machine-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system: memories or registers or other such information storage devices.

The present disclosure also relates to an apparatus for performing the operations herein. This apparatus may be specially constructed for the intended purposes, or it may comprise a computer selectively activated or reconfigured by a computer program stored in the computer. Such a computer program may be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The operations and illustrations presented herein are not inherently related to any particular computer or other apparatus. Various types of systems may be used with programs in accordance with the teachings herein, or it may prove convenient to construct a more specialized apparatus to perform the operations. The structure for a variety of these systems will appear as set forth in the description herein. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as read-only memory (“ROM”), random access memory (“RAM”), magnetic disk storage media, optical storage media, flash memory devices, etc.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIGS. 4 and 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents. In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A method for asymmetric multi-party computation, the method comprising:
establishing data communications channels over a computerized network among a set of distributed computerized processors, wherein a first subset of the computerized processors are at relatively fast parties and a second subset of the computerized processors are at relatively slower parties;
identifying the set of fast parties and the set of slow parties based on predetermined or detected network performance metrics, wherein channels between fast parties have a relatively small delay, and channels that contain at least one slow party have a relatively large delay;
during a pre-processing phase, the set of fast parties performing an oblivious transfer (OT)-extension protocol to establish an OT channel between each pair of fast parties to generate correlated randomness values for the fast parties, wherein the fast parties do not know the other values;
electronically storing a set of inputs at the set of slow parties and the set of fast parties, wherein the input at any party is unique and not known to the other parties;
at each of the fast parties, executing an unconditional OT-based protocol over the communication channels for dishonest majority to execute instructions for generating an output;
electronically storing the output of the execution of the instructions at each of the fast parties; and
transmitting over the data communications channels the output from each of the fast parties to each of the other fast parties and each of the slow parties.

2. The method of claim 1, wherein there is an honest majority t<n/2 of parties.

3. The method of claim 1, wherein the total number of communicated bits over channels with relatively larger delay is independent of a circuit size.

4. The method of claim 1, wherein the slow parties do not perform the executable instructions.

5. The method of claim 1, wherein the correlated randomness values are generated using an honest-majority multi-party computation (MPC) protocol.

6. The method of claim 1, wherein the correlated randomness is generated by a trusted dealer distributing k OT correlations among the fast parties directly, wherein k is a security parameter.

7. The method of claim 1, wherein the slow parties only generate correlated randomness values for the multi-party computation (MPC).

8. A system for asymmetric multi-party computation, the system comprising:
a network device configured for establishing data communications channels over a computerized network among a set of distributed computerized processors, wherein a first subset of the computerized processors are at relatively fast parties and a second subset of the computerized processors are at relatively slower parties;
a set of processors configured for:
identifying the set of fast parties and the set of slow parties based on predetermined or detected network performance metrics, wherein channels between fast parties have a relatively small delay, and channels that contain at least one slow party have a relatively large delay;
during a pre-processing phase, the set of fast parties performing an oblivious transfer (OT)-extension protocol to establish an OT channel between each pair of fast parties to generate correlated randomness values for the fast parties, wherein the fast parties do not know the other values;
electronically storing a set of inputs at the set of slow parties and the set of fast parties, wherein the input at any party is unique and not known to the other parties;
at each of the fast parties, executing an unconditional OT-based protocol over the communication channels for dishonest majority to execute instructions for generating an output;
electronically storing the output of the execution of the instructions at each of the fast parties; and
transmitting over the data communications channels the output from each of the fast parties to each of the other fast parties and each of the slow parties.

9. The system of claim 8, wherein there is an honest majority t<n/2 of parties.

10. The system of claim 8, wherein the total number of communicated bits over channels with relatively larger delay is independent of a circuit size.

11. The system of claim 8, wherein the slow parties do not perform the executable instructions.

12. The system of claim 8, wherein the correlations the correlated randomness values are generated using an honest-majority multi-party computation (MPC) protocol.

13. The system of claim 8, wherein the correlated randomness is generated by a trusted dealer distributing k OT correlations among the fast parties directly, wherein k is a security parameter.

14. The system of claim 8, wherein the slow parties only generate correlated randomness values for the multi-party computation (MPC).

15. A non-transitory processor-readable medium storing code representing instructions to be executed by a processor at a compute device for asymmetric multi-party computation, the code further comprising commands for:
establishing data communications channels over a computerized network among a set of distributed computerized processors, wherein a first subset of the computerized processors are at relatively fast parties and a second subset of the computerized processors are at relatively slower parties;
identifying the set of fast parties and the set of slow parties based on predetermined or detected network performance metrics, wherein channels between fast parties have a relatively small delay, and channels that contain at least one slow party have a relatively large delay;
during a pre-processing phase, the set of fast parties performing an oblivious transfer (OT)-extension protocol to establish an OT channel between each pair of fast parties to generate correlated randomness values for the fast parties, wherein the fast parties do not know the other values;
electronically storing a set of inputs at the set of slow parties and the set of fast parties, wherein the input at any party is unique and not known to the other parties;
at each of the fast parties, executing an unconditional OT-based protocol over the communication channels for dishonest majority to execute instructions for generating an output;
electronically storing the output of the execution of the instructions at each of the fast parties; and
transmitting over the data communications channels the output from each of the fast parties to each of the other fast parties and each of the slow parties.

16. The media of claim 15, wherein there is an honest majority t<n/2 of parties.

17. The media of claim 15, wherein the total number of communicated bits over channels with relatively larger delay is independent of a circuit size.

18. The media of claim 15, wherein the slow parties do not perform the executable instructions and wherein the slow parties only generate correlated randomness values for the multi-party computation (MPC).

19. The media of claim 15, wherein the correlated randomness values are generated using an honest-majority multi-party computation (MPC) protocol.

20. The media of claim 15, wherein the correlated randomness is generated by a trusted dealer distributing k OT correlations among the fast parties directly, wherein k is a security parameter.
